(19) United States
(12) Patent Application Publication
(10) Pub. No.: US 2006/0151575 A1
(43) Pub. Date: Jul. 13, 2006

(54) Method of producing shaped bodies, particularly cores, molds and feeders for use in foundry practice

(76) Inventors: Antoni Gienic, Hilden (DE); Henning Rehse, Wermel-Iskirchen (DE); Dieter Koch, Mettmann (DE); Gunter Weicker, Solingen (DE); Dietmar Chmielewski, Dusseldorf (DE)

Correspondence Address: Scott R Cox;Lynch Cox Gilman & Mahan, Suite 2100, 500 West Jefferson Street, Louisville, KY, 40202, US

(21) Appl. No.: 10/537,530

(22) PCT Filed: Dec. 5, 2003
(86) PCT No.: PCT/EP03/13777

§ 371 Date: Oct. 11, 2005

(30) Foreign Application Priority Data
Dec. 5, 2002 (DE) 10256953.3

(51) Int. Cl. A47J 36/02

(52) U.S. Cl. 228/101

(57) ABSTRACT

The present invention relates to a process for producing shaped bodies, in particular cores, molds and feeders in foundry technology, which comprises the following steps: a. Preparation of a composition comprising i. at least one phenolic resin in solid form, ii. at least one polyisocyanate, and iii. at least one refractory material, with the composition being prepared at a temperature which is below the melting point of the at least one phenolic resin; b. Molding of the composition to form a shaped body; c. Raising of the temperature of the composition to above the melting point of the at least one phenolic resin to cure the mixture. The invention also relates to shaped bodies, in particular cores, molds and feeders for foundry technology, which are obtainable by this process, and also a composition as is used in this process.

The present invention relates to a process for producing shaped bodies, in particular cores, molds and feeders in foundry technology, shaped bodies obtained using this process and also a composition as is used in this process.

Such shaped bodies are required in two embodiments: as cores or molds for producing castings, and as hollow bodies (known as feeders) for accommodating the liquid metal as equilibration reservoir for preventing casting flaws caused by shrinkage during solidification of the metal. The mixtures for producing such shaped bodies comprise a refractory material, for example silica sand, whose grains are joined by means of a suitable binder after removal of the shaped body from the mold in order to achieve satisfactory mechanical strength of the casting mold.

The shaped bodies have to meet various requirements. In the casting process itself, they firstly have to have a sufficient stability and heat resistance in order to take up the liquid metal in the hollow mold formed by one or more shaped bodies. After commencement of the solidification process, the mechanical stability of the mold is ensured by the solidified metal layer which has formed along the wall of the hollow mold. The material of the shaped body then has to decompose under the action of the heat given off by the metal so that it loses its mechanical strength, i.e. the cohesion between the individual grains of refractory material is destroyed. This is achieved by, for example, the binder decomposing under the action of heat. After cooling, the solidified casting is vibrated, and in the ideal case the material of the parts of the mold disintegrates again to a fine sand which can be poured from the hollow spaces of the metal casting.

Among processes for producing the shaped bodies mentioned, a distinction is made between cold and hot processes.

In cold processes, gas curing has attained a dominant position.

In the case of gas curing in the polyurethane cold box process, a two-component system is used. The first component comprises the solution of a polyol, usually a phenolic resin. The second component is the solution of a polyisocyanate.

According to U.S. Pat. No. 3,409,579 A, the two components of the polyurethane binder are reacted by passing a gaseous tertiary amine through the mold material/binder mixture after shaping.

The curing reaction of polyurethane binders is a poly-addition, i.e. a reaction without elimination of by-products such as water. Further advantages of this cold box process include good productivity, dimensional accuracy of the shaped bodies and good technical properties (strengths, processing time of the mold material/binder mixture, etc.).

However, the advantages mentioned are offset by certain weaknesses of the polyurethane cold box process, for example emissions of the amine used as catalyst which has to be extracted and removed in an acid scrubber, which costs money, and emissions of vaporizing solvents and residual monomers in the production of cores and especially in the storage of cores.

Hot-curing (hot) processes include the hot box process based on phenolic resins or furan resins, the warm box process based on furan resins and the Croning process based on phenolic novolak resins.

The hot-curing processes have over many years stabilized their position in the production of cores for foundry technology. In the first two technologies, viz. hot box and warm box, liquid resins are processed with a latent hardener which only becomes effective at elevated temperatures to form a mold material mixture.

In the Croning process, mold materials such as silica sand, chromite sand, zircon sand, etc., are coated at a temperature of about 100-160° C. with a phenolic novolak resin which is liquid at this temperature. As reactant for later curing, hexamethylene tetramine is added.

Shaping and curing take place, in the case of the abovementioned hot-curing technologies, in heatable tools which are heated to a temperature of up to 300° C.

Binders suitable for hot curing generally contain water which has to be driven off during curing. Since curing is, in chemical terms, a polycondensation, further water which likewise has to be removed is formed during curing.

Further disadvantages include the elimination of formaldehyde during curing, particularly in the case of Croning sands, so that these processes, too, cannot be considered free of emissions.

Binders are also used in other systems in which particles of various materials are bound together to give shaped bodies having particular properties. However, these binder systems are generally not suitable for use in producing parts of molds for foundry technology since they do not have the required properties, viz. high thermal and mechanical stability at the beginning of the casting process and ready disintegration as solidification of the metal melt progresses.

EP 0 022 215 A1 describes a process for producing shaped bodies based on polyurethane. Here, polyisocyanates are firstly reacted with polyhydroxyl compounds, for example novolaks, in an NCO/OH equivalence ratio of from 0.8:1 to 1.2:1 in a first reaction step to give a solid, pulverizable and fusible product which still has free isocyanate and hydroxyl groups. This product is subsequently cured in a second reaction step after or with simultaneous shaping by heating to from 100 to 250° C. to give a crosslinked, no longer fusible shaped body. The process is particularly suitable for producing shaped bodies for the electrical industry, e.g. insulators, components of switches, encapsulation of electronic components, transformers, transducers, or for producing binders for thermally crosslinkable powder coatings or solvent-containing coating compositions for producing coatings of any type. The process is not suitable for producing shaped bodies for foundry technology, since the parts of the mold do not have the required properties in respect of decomposition under the action of heat.

WO 00/36019 describes a binder composition for producing composite wood materials. The wood chips are mixed with a binder composition which is composed essentially of a polyphenyl isocyanate and a solid resol resin and shaped to produce the desired shaped body. In the examples, the polymerization of the binder is carried out without addition of a solvent. As a result of wood chips being used, the thermal stability required for shaped bodies for foundry technology is not ensured.

DE 21 43 247 A describes heat-curable molding compositions for producing friction bodies. The polymeric binder is produced from phenolics which contain prepolymerized isocyanate compounds. In the prepolymerization, a trimerization catalyst is additionally added to the isocyanate compounds. Fillers mentioned are, for example, asbestos or metal oxides. This document, too, gives no starting point for improvements in the field of shaped bodies for foundry technology, since the friction bodies are not supposed to disintegrate under the action of high temperatures but are instead intended to have a very high stability.

EP 0 362 486 A2 describes mold materials which comprise a particulate material and a binder. The mold materials are used for producing shaped bodies for foundry technology, for example for producing cores and feeders. The binder comprises a phenolic novolak whose molar ratio of phenol to formaldehyde is from 1:0.25 to 1:0.5. The phenolic novolak is dissolved in a suitable solvent and mixed with the particulate material and a polyisocyanate to produce the mold material. After shaping, the shaped bodies are cured by addition of a gaseous catalyst. This document describes a modification of the cold box process in which a particular type of phenolic resins is used. However, this process leads to the same disadvantages which have been described above, namely emission of catalyst and solvent during storage and severe smoking during casting.

The problems of emissions in production, storage and use, especially of feeders, and the lack of disintegration of the remains of the feeders after casting have been known for a long time.

None of the conventional processes, viz. green stage processes, CO₂ gassing processes, slip filter processes or cold box processes, has hitherto been able to solve the abovementioned problems.

It is therefore an object of the present invention to provide a process for producing shaped bodies, in particular cores, molds and feeders for foundry technology, in which the disadvantages of the prior art are avoided. In particular, the shaped bodies produced by the process of the invention should display minimal emissions and low gas evolution and condensate formation (formation of cracked products) during casting and also a very good dimensional stability.

The inventors have surprisingly found that the emissions, vapors and smoke arising hitherto in the production, storage and use of shaped bodies, in particular feeders, can be reduced or avoided entirely while at the same time ensuring optimal disintegration of the residues of the feeder after casting by curing a composition based on a solid phenolic resin, polyisocyanate and a refractory material by heating. In this process, the polyurethane reaction, which is a polyaddition, is carried out by hot curing of at least one phenolic resin in solid form, preferably as powder, with at least one liquid or solid polyisocyanate.

In detail, the process is carried out by firstly preparing a composition comprising at least the following constituents:
i. at least one phenolic resin in solid form;
ii. at least one polyisocyanate; and
iii. at least one refractory material.

Here, phenolic resin and polyisocyanate form the binder to bind together the grains of the refractory material. The composition is prepared at a temperature which is below the melting point of the at least one phenolic resin.

The abovementioned constituents of the composition are used in customary ratios. Based on the total mass of the composition, the binder formed by phenolic resin and polyisocyanate makes up a proportion of less than 10% by weight, preferably less than 8% by weight, particularly preferably less than 4% by weight. In the production of, in particular, cores and molds, the proportion of binder is preferably less than 2% by weight, particularly preferably in the range from 0.5 to 1.6% by weight. In the production of feeders, the binder can be used in amounts similar to or the same as those mentioned above when solid refractory materials such as silica sand or chamotte are used. If refractory materials having a lower density, in particular hollow microspheres, are used, the proportion of binder, based on the weight, is increased. Due to the low density of these hollow microspheres, proportions of binder of preferably less than 10% by weight, particularly preferably in the range from 6 to 8% by weight, are used.

Solid refractory materials, for example silica sand, have a bulk density in the range from about 120 to 200 g/100 ml. Based on the total mixture, the binder is then preferably present in amounts of less than 4 g/100 ml, in particular less than 3 g/100 ml, particularly preferably in the range from 1 to 2.8 g/100 ml.

If hollow microspheres are used, these have a bulk density in the range from about 30 to 50 g/100 ml. Corresponding amounts of binder are then used, preferably amounts of less than 6 g/100 ml, particularly preferably less than 4 g/100 ml and in particular in the range from 1 to 3.5 g/100 ml. The reference parameter of 100 ml employed here is based on the poured volume.

The bulk density or the poured volume are determined by firstly weighing a 100 ml cylinder which has been cut off at the 100 ml mark. A powder funnel is then placed on top of this measuring cylinder and the material to be measured, i.e., for example, the refractory material or the composition, is poured in without interruption. The powder funnel is then taken off, so that a cone of the material to be measured is formed above the opening of the measuring cylinder. The material above the top of this cylinder is struck off by means of a spatula, so that the measuring cylinder is filled flush to its upper edge. After material adhering to the outside of the measuring cylinder has been removed, the measuring cylinder is weighed again. Subtraction of the weight of the measuring cylinder gives the poured weight per 100 ml. The amount of binder present in the composition per 100 ml can then also be calculated from this.

The larger amount of binder required when using hollow microspheres can also be explained by their higher specific surface area. Thus, solid refractory materials such as silica sand preferably have a mean particle diameter in the range from about 0.2 to 0.4, while the diameter of the hollow microspheres is usually a power of ten lower, i.e. in the range from about 0.02 to 0.04 mm.

The balance of the composition to 100% by weight is formed by the refractory material. If the composition comprises further constituents, their proportion is at the expense of the refractory material.

Thus, a solid phenolic resin or a mixture of two or more phenolic resins is used as first component of the binder. For the definition of phenolic resins, reference may be made, for the purposes of the present invention, to, for example, the reference Rompp Lexikon Chemie, 10th edition (1998), pages 3251-3253. In particular, phenolic resins are formed in a condensation reaction of phenols and aldehydes, in particular formaldehyde, in acidic and alkaline solution. Apart from phenol itself, homologues or derivatives of phenol, in particular alkyl derivatives (cresols, xylenols, butylphenol, nonylphenol, octylphenol) and aryl derivatives (phenylphenol), bifunctional phenols (resorcinol, bisphenol A) and naphthols are also suitable for preparing these resins.

The phenolic resins resulting from condensation reactions of phenols with aldehydes can be divided into novolaks and resols. For the purposes of the present invention, both solid novolaks and solid resols can be used. However, preference is given to novolaks. Thus, it has been found according to the present invention that particularly advantageous shaped bodies are obtained when solid novolaks are used in the composition. This may be partly attributable, without wishing to be restricted to this mechanism, to part of the methylol groups present in resols being able to be eliminated again with emission of formaldehyde under the action of the heat required for curing. The most important aldehyde component for preparing phenolic resins is formaldehyde in a variety of commercial forms (aqueous solution, paraformaldehyde, formaldehyde-eliminating compounds, etc.). Other aldehydes, e.g. acetaldehyde, benzaldehyde or acrolein, are used only to a relatively minor extent for preparing phenolic resins. However, the use of ketones as carbonyl compound is also conceivable.

For the purposes of the present invention, the expression “solid phenolic resin” or “phenolic resin in solid form” refers to any phenolic resin which is present in solid form at the temperatures employed during preparation of the composition comprising the phenolic resin and the polyisocyanate, i.e. before curing at elevated temperatures. It is preferably a phenolic resin whose melting point is below about 120° C., in particular in the range from about 60 to 110° C., particularly preferably from about 60 to 100° C.

The second component of the composition is at least one polyisocyanate. Here, it is possible to use all compounds having at least two isocyanate groups (functionality ≧2). This encompasses aliphatic, cycloaliphatic or aromatic polyisocyanates. Owing to their reactivity, aromatic polyisocyanates such as diphenylmethane diisocyanate in admixture with its higher homologues (known as polymeric MDI) are preferred. Particular preference is given to functionalities in the range from 2 to 4, in particular from 2 to 3.

Phenolic resin and polyisocyanate are preferably used in an equivalent ratio based on their reactive hydroxy or isocyanate groups. The ratio of the reactive hydroxy groups of the phenolic resin to the isocyanate groups of the polyisocyanate is preferably in the range from 0.8:1 to 1.2:1.

As refractory materials, it is in principle possible to use all refractory materials which are customary in the production of shaped bodies for foundry technology. Suitable refractory materials are, for example, silica sand, olivine, chromite sand, zircon sand, vermiculite and synthetic mold materials such as Cerabeads or hollow aluminum silicate spheres (known as microspheres) which can be held together by means of the above-described binders. These and further additional components can be added or mixed in in a customary fashion before, during or after preparation of the composition, but before curing of the composition.

The composition is prepared at a temperature which is below the melting point of the at least one phenolic resin. Customary mixing processes are used. For example, phenolic resin and refractory material can firstly be intimately mixed in a mixer and the polyisocyanate can then be added. However, the order in which the individual components of the composition are mixed can also be altered.

The above-described components i to iii can thus, in one embodiment, each be introduced separately into a mixer in order to obtain the composition. However, it is also possible firstly to mix the at least one refractory material with the phenolic resin, in particular to coat the at least one refractory material with the phenolic resin, to give a mixture of solid refractory material and phenolic resin from which the composition is subsequently prepared by addition of the at least one polyisocyanate.

This can be achieved by melting the phenolic resin and then mixing it with the at least one refractory material which is in particulate or pulverulent form. This results in the particles of the at least one refractory material being coated with the phenolic resin. The mixture is subsequently cooled back down below the solidification point of the phenolic resin so that the particles of the refractory material are surrounded by a shell of solid phenolic resin. Further processing is then carried out as described above. The polyisocyanate is added at a temperature below the melting point of the at least one phenolic resin in order to obtain the composition.

The composition is subsequently brought to the desired shape. Here too, processes customary for shaping are used. The shaped body then still has a relatively low mechanical stability. To cure it, the temperature of the composition is increased to above the melting point of the at least one phenolic resin.

Curing of the composition or of the shaped bodies produced therewith can be carried out at a temperature of about 150-300° C., in particular about 170-270° C., particularly preferably about 180-250° C. At a temperature above the melting point of the at least one phenolic resin, the solid resin melts and, as liquid component, undergoes an addition reaction with the polyisocyanate present. The reaction between the two liquid components proceeds very rapidly and leads, as in the known hot-curing processes, to curing of the shaped bodies.

At temperatures below the melting point of the at least one phenolic resin, only a slight reaction between the binder components, i.e. the phenolic resin and the isocyanate, takes place, i.e. the processing time of the mold material/binder mixture is sufficiently long, preferably at least a few hours after the preparation of the composition, for it to be able to be processed to form shaped bodies with excellent results after its preparation.

The process of the invention is particularly useful, in the field of foundry technology, both for producing cores or molds and for producing hollow bodies, namely feeders.

For the purposes of the present invention, cores and molds are bodies which are employed to form internal and external contours of castings. They comprise mold materials (base materials for the mold) or refractories which can be strengthened by means of a binder.

The shaped bodies can also be configured as feeders. Feeders are in principle hollow spaces which are connected to the hollow space of the casting mold, are filled with liquid metal by the casting stream and are dimensioned and configured so that the setting modulus of the feeder is greater than that of the casting.

In foundry technology, shaping and curing, in particular of the molds, cores and feeders, comprising the composition can be carried out in heated tools. A person skilled in the art will be familiar with these.

It is possible to make the feeders of a thermally insulating and/or heat-releasing (exothermic) composition. The insulating effect is obtained by the use of refractory materials which can be partly present in the form of fibers and which have a very low thermal conductivity. In relatively recent developments of the last few years, hollow microspheres based on aluminum silicate have also been found to be very effective. Examples of such hollow microspheres are Extendospheres SG (PQ Corporation) and U-Spheres (Omega Minerals Germany GmbH) having an aluminum oxide content of from about 28 to 33%, and also Extendospheres SLG (PQ Corporation) and E-Spheres (Omega Minerals Germany GmbH) having an aluminum oxide content of more than 40%. Exothermic compositions further comprise, in addition to the refractory materials, oxidizable metals such as aluminum and/or magnesium, oxidants such as sodium nitrate or potassium nitrate and, if desired, fluorine carriers such as cryolite. Both insulating and exothermic mixtures are known and are described, for example, in EP 0 934 785 A1, EP 0 695 229 B1 and EP 0 888 199 B1.

The oxidizable metals and the oxidants are added in customary amounts as are also described, for example, in the patent publications mentioned. The metals preferably make up a proportion of from 15 to 35% by weight of the total mass of the composition. The oxidant preferably makes up a proportion of from 20 to 30% by weight. The proportions are also dependent on the molecular weight of the oxidant and of the oxidizable metal.

The polyisocyanates used according to the invention can also, if necessary, be dissolved in solvents. Solvents used are nonpolar or weakly polar substances such as aromatic solvents or fatty acid esters. Strongly polar solvents such as esters or ketones partly dissolve the solid novolak and lead, even at room temperature, to an undesirable, drastic shortening of the processing time of the mold material/binder mixture. However, particular preference is given to solvents being absent in the compositions and the shaped bodies produced therefrom, in particular solvents for the at least one phenolic resin being absent and solvents for the at least one polyisocyanate being absent, since surprisingly good results in respect of the properties of the cured shaped bodies have been achieved in this way.

Liquid isocyanates, in particular polymeric MDI, are preferred. However, the reaction can in principle also be carried out using solid isocyanates, e.g. naphthalene 1,5-diisocyanate or the likewise solid capped isocyanates, e.g. Desmodur AP stabil (Bayer AG). However, curing proceeds significantly more slowly when these isocyanates are used. For the purposes of the present invention, liquid polyisocyanates are ones which are in liquid form at the temperatures employed during the preparation of the composition comprising the phenolic resin and the polyisocyanate (in particular at room temperature), i.e. before curing at elevated temperatures.

The at least one phenolic resin preferably comprises a novolak, with the melting point of the phenolic resin or novolak being below about 120° C., in particular from about 60 to 110° C., particularly preferably from about 60 to 100° C.

Curing is preferably carried out at a temperature of from 150° C. to 300° C., in particular from 170° C. to 270° C., particularly preferably from 180° C. to 250° C.

Curing is preferably carried out without addition of a catalyst. Even just heating the above-described composition gives a sufficiently high crosslinking rate to make industrial production of the shaped bodies possible.

However, to achieve a further increase in the rate at which the shaped bodies are cured, catalysts in liquid or solid form can also be added to the composition. These can be, for example, amines and metal compounds as are known as catalysts from polyurethane chemistry. Examples of suitable amine compounds are tetramethyl-butanediamine (TMBDA), 1,4-diaza[2.2.2]bicylcooctane (DABCO) and dimethylcyclohexylamine. The amine compounds used as catalysts preferably have a low volatility and a boiling point under standard conditions of above 150° C., preferably above 200° C. In contrast to catalysts which are used in the cold box process and have a low boiling point of usually significantly less than 100° C., these high-boiling amines cause no emissions, or only extremely low emissions, in the finished, cured shaped bodies. In one embodiment of the invention, a solid catalyst can also be added to the composition to accelerate curing. For the purposes of the present invention, a solid catalyst is a catalyst which is in solid form at room temperature. Particularly preferred catalysts are compounds of tin, in particular organic compounds of tin such as dibutyltin dilaurate (DBTL), dibutyltin oxide (DBTO), tin dioctoate or diethyltin chloride. Among these, DBTL is particularly preferred.

The solid and liquid catalysts are preferably added to the composition in an amount of 0.01-10% by weight, preferably 0.1-8% by weight, particularly preferably 0.2-6% by weight, with the percentages in each case being based on the amount of binder, i.e. on the sum of the phenolic resin and the polyisocyanate used. The liquid catalysts are used in smaller amounts than are the solid catalysts. Here, an amount in the range 0.01-1% by weight, preferably 0.1-0.5% by weight, is usually sufficient.

These solid and liquid catalysts have a very high effectiveness. To aid metered addition, these solid and liquid catalysts can therefore be diluted with an inert solvent. For the purposes of the present invention, inert solvents are solvents which do not undergo any reaction with the catalyst, the polyisocyanate and the phenolic resin and do not dissolve the phenolic resin, or dissolve it to a very small extent. Suitable solvents are aromatic solvents such as toluene or xylene. The amount of solvent is preferably kept low so that precise metering of the catalyst is made possible but a very small amount of residual solvent is introduced into the shaped bodies. The solutions preferably have a catalyst concentration in the range from 1 to 50% by weight, preferably from 2 to 10% by weight.

In addition, the composition can further comprise a carboxylic acid, for example salicylic acid or oxalic acid. Although acids tend to act as inhibitors in the production of polyurethanes, it has surprisingly been found that an addition of carboxylic acids accelerates the reaction, i.e. curing. Without wishing to be tied to this theory, the inventors assume that the carboxylic acids lower the melting point or the melt viscosity of the phenolic resin. The carboxylic acids are added in amounts as have been indicated for the catalysts.

Apart from the abovementioned constituents, the composition can further comprise other customary constituents in customary amounts. The use of internal mold release agents, e.g. calcium stearate, silicone oils, fatty acid esters, waxes, natural resins or specific alkyd resins, aids detachment of the cores from the mold. The storage of the cured shaped bodies and their resistance to high atmospheric humidity can be improved by addition of silanes.

The shaped bodies for foundry technology produced by the process of the invention display a low emission of pollutants. Since preference is given to using no solvent and no gaseous catalyst for the production of the shaped bodies, no amines, for example, are given off during storage, so that no corresponding odor pollution has to be reckoned with. In addition, there is significantly reduced smoke evolution in the casting process itself compared to shaped bodies produced by the cold box process. The invention therefore also provides shaped bodies, in particular cores, molds and feeders for foundry technology, which have been obtained by the above-described process.

These shaped bodies are preferably free of solvents and/or gaseous catalysts.

The shaped bodies of the invention are suitable for the casting of light metals, in particular the casting of aluminum. The gas-forming binder systems of the prior art frequently result in gas porosity in this case. The organic binder system present in the composition of the invention displays only low gas and condensate formation during casting combined with very good disintegration. The above-described difficulties caused by gas porosity can therefore be avoided or at least reduced significantly. Owing to the good disintegration properties, the shaped bodies are particularly suitable as cores and molds in the casting of light metals, in particular the casting of aluminum. However, the use of the shaped bodies of the invention is not restricted to casting of light metals. They are generally suitable for the casting of metals. Such metals are, for example, copper alloys such as brass or bronzes, and also ferrous metals.

The invention further provides a composition for producing shaped bodies, in particular cores, molds and feeders, comprising at least
a. a solid phenolic resin,
b. at least one polyisocyanate, and
c. at least one refractory material.

The individual components correspond to the components as have been explained in the description of the process of the invention.

In a particularly preferred embodiment, the refractory material comprises hollow microspheres, preferably hollow microspheres based on aluminum silicate, in particular ones having a high aluminum oxide content of more than about 40% by weight, or a lower aluminum oxide content of from about 28 to 33% by weight.

The composition preferably contains no solvent for the at least one phenolic resin and/or no solvent for the at least one polyisocyanate, and in particular no solvent at all is present.

The at least one phenolic resin preferably comprises a novolak, and the melting point of the phenolic resin or novolak is preferably in the range from about 60 to 120° C., in particular from about 60 to 110° C., particularly preferably from about 60 to 100° C.

Apart from the constituents mentioned, the composition can, as described above for the process of the invention, further comprise customary constituents. Thus, both oxidizable metals and suitable oxidants can also be present in the composition for the production of exothermic feeders. In addition, the composition can also contain internal mold release agents, solid and/or liquid catalysts or carboxylic acids or agents for reducing the melting point of the phenolic resin.

The binder mixture present in the composition of the invention for producing shaped bodies, in particular cores, molds and feeders, is suitable in general for improving the strength of the shaped bodies, for reducing the hot deformation of the shaped bodies, evolution of smoke, gas and condensate formation, odor during storage, for improving the casting properties, in particular the tendency for flash to be formed and erosion to occur during casting, or any combination of the above properties. In particular, the disintegration both of the cores and molds and also of the residues of feeders after casting can be improved by means of this binder composition.

The invention is illustrated by the following nonlimiting examples:

### EXAMPLES

1. Preparation and Testing of Mold Material/Binder Mixtures

1.1 Production of Cores Comprising Silica Sand

For the production of cores for laboratory testing of the sand-related and casting properties, silica sand H 32 (Quarzwerke GmbH, Frechen) was used as mold material.

1.1.1. Cold Box (Comparative Example)

100 pbw of silica sand H 32

0.8 pbw of Isocure® 366¹

0.8 pbw of Isocure® 666¹

¹Commercial products of ASK, Hilden

Isocure® 366: benzyl ether resin dissolved in a mixture of esters, ketones and aromatics;

Isocure® 666: technical-grade diphenyl-methane diisocyanate, dissolved in aromatics.

0.8 pbw (part by weight) of Isocure® 366 and 0.8 pbw of Isocure® 666 are in each case added in succession to 100 pbw of silica sand H 32 and mixed intensively in a laboratory mixer having a utilizable capacity of 5 kg from Vogel & Schemmann. Test specimens (Georg-Fischer bars having the dimensions 150 mm×22.36 mm×22.36 mm) are produced using this mixture and are cured by treatment with triethylamine gas (0.5 ml per test bar, 2 bar gas pressure, 10 sec. contact time).

1.1.2. Warm Box (Comparative Example)

100 pbw of silica sand H 32

0.30 pbw of Hotfix® WB 220²

1.30 pbw of Kernfix® WB 185²

² Commercial products of ASK, Hilden;

Hotfix® WB 220: aqueous solution of a sulfonic acid;

Kernfix® WB 185: phenol/urea/formaldehyde cocondensate, dissolved in furfuryl alcohol.

0.30 pbw of Hotfix® WB 220 and 1.30 pbw of Kernfix® WB 185 are added in succession to 100 pbw of silica sand H 32 and intensively mixed in a laboratory mixer (see above).

Test specimens (Georg-Fischer bars, see above) are produced using this mixture and are cured in a heated mold core production machine H2 from Röper, Dülken, at a temperature of 220° C. for 30 seconds.

1.1.3. Hot Polyurethane Curing (According to the Invention)

As resin component, the solid phenolic resins listed in Table I were used. Table I Manufacturer Name

TABLE I

| | Manufacturer | Name |
|---|---|---|
| 1.1.3.1. | Solutia Germany GmbH & Co. KG | Alnovol ® PN 332 |
| 1.1.3.2. | Perstorp AB. Sweden | Peracit ® 4018 F |
| 1.1.3.3. | Bakelite AG | Bakelite ® 0235 DP |

Diphenylmethane diisocyanate (technical grade MDI) having a functionality of about 2.7 from Bayer AG was used as component 2.

100 pbw of silica sand H 32

0.8 pbw of solid phenolic resin

0.8 pbw of technical-grade MDI

0.8 pbw of solid phenolic resin and 0.8 pbw of technical-grade MDI are added in succession to 100 pbw of silica sand H 32 and intensively mixed in a laboratory mixer (see above). Test specimens (see above) are produced using this mixture and are cured in heated molds at a temperature of 250° C. for 30 seconds.

1.1.4. Hot Polyurethane Curing with Addition of Reaction Accelerators

1.1.4.1. Addition of a Liquid Catalyst

Example 1.1.3.1 was repeated with further addition of 0.08 part by weight of a 5% strength solution of dibutyltin dilaurate (DBTL) in an aromatic solvent to the sand/binder mixture. This enabled the curing time at the same curing temperature as in 1.1.3.1 to be shortened by about 50%.

1.1.4.2. Addition of Salicylic Acid

Example 1.1.3.1 was repeated with further addition of 0.08 part by weight of salicylic acid to the sand/binder mixture. This enabled the curing time at the same curing temperature as in 1.1.3.1 to be shortened by about 50%.

1.1.4.3. Combination of Reaction Accelerators

Example 1.1.3.1 was repeated with further addition of 0.08 part by weight of salicylic acid and 0.08 part by weight of a 5% strength solution of dibutyltin dilaurate (DBTL) in an aromatic solvent to the sand/binder mixture. This enabled the curing time at the same curing temperature as in 1.1.3.1 to be shortened by about 70%.

1.2. Strength Comparison

Table II reports the flexural strengths of the cores from examples 1.1.1, 1.1.2 and 1.1.3, with test specimens having the dimensions 150 mm×22.36 mm×22.36 mm (Georg-Fischer bars) being used.

TABLE II

| | Strengths |
|---|---|
| | (24 h after production of the core) |
| Example 1.1.1 | 650 N/cm² |
| Example 1.1.2 | 750 N/cm² |
| Example 1.1.3.1 | 800 N/cm² |
| Example 1.1.3.2 | 700 N/cm² |
| Example 1.1.3.3 | 750 N/cm² |

1.3. Comparison of Hot Deformation

24 hour old cores having the dimensions 150×22.36×11.18 mm were loaded with a weight of 200 g, 400 g or 600 g in the middle of the core for 30 minutes at a temperature of 150° C. After cooling of the cores, the deformation of the cores was measured.

TABLE III

| | Loading with | | | |
|---|---|---|---|---|
| | 200 g | 400 g | 600 g | |
| Example 1.1.1 | 0.34 mm | 0.38 mm | 1.2 | mm |
| Example 1.1.2 | 0.20 mm | 0.24 mm | 0.32 | mm |
| Example 1.1.3.1 | 0.04 mm | 0.05 mm | 0.08 | mm |
| Example 1.1.3.2 | 0.05 mm | 0.05 mm | 0.09 | mm |
| Example 1.1.3.3 | 0.03 mm | 0.06 mm | 0.07 | mm |

The surprisingly low hot deformation of the cores produced using the binder mixture according to the invention compared to the cores produced by known cold box or warm box processes is apparent.

1.4. Comparison of Smoke Evolution

The smoke intensity was determined photo-metrically by an ASK method. For this purpose, 24 hour old cores having the dimensions 30 mm×22.36 mm×22.36 mm were stored in a closed crucible for 3 minutes at a temperature of 650° C. The smoke formed in the thermal decomposition of the binder was subsequently drawn through a flow cell by means of a vacuum pump and its intensity was measured by means of a DR/2000 spectro-photometer from Hach.

TABLE IV

| | Smoke intensity |
|---|---|
| Example 1.1.1 | 0.65 |
| Example 1.1.3.1 | 0.30 |
| Example 1.1.3.2 | 0.35 |
| Example 1.1.3.3 | 0.30 |

1.5. Comparison of the Odor on Storage of the Cores

Cores produced as described in 1.1 were subjected after prescribed times to an independent odor evaluation by three persons. The result is reported in Table V.

| | Odor assessment after production of the core | | |
|---|---|---|---|
| Table V | 5 min. | 2 hours | 24 hours |
| Example 1.1.1 | strongly of | strongly of | strongly of |
| | solvent and | solvent | solvent |
| | amine | | |
| Example 1.1.2 | of | barely | barely |
| | formaldehyde | perceptible | perceptible |
| Example 1.1.3.1 | barely | barely | barely |
| | perceptible | perceptible | perceptible |
| Example 1.1.3.2 | barely | barely | barely |
| | perceptible | perceptible | perceptible |
| Example 1.1.3.3 | barely | barely | barely |
| | perceptible | perceptible | perceptible |

1.6. Comparison of the Tendency of the Binder to Form Flash and for Erosion to Occur During Casting

For the assessment of casting performance, the binders from examples 1.1.1 and 1.1.3.1 were employed. The experiment was carried out using the dome core test (Casting center of the Institute of Metals T.N.O., TV Netherlands, publication 77, August 1960). A gray cast iron GG 25 was used at a casting temperature of 1390-1410° C.

For the evaluation, grades ranging from 1 (no casting flaws) to 10 (severe casting flaws) were awarded

The result is reported in Table VI.

TABLE VI

| | Example 1.1.1 | Example |
|---|---|---|
| | (cold box cores) | 1.1.3.1 |
| Sized cores, flash | 5 | 2 |
| Sized cores, erosion | 1 | 1 |
| Unsized cores, flash | 10 | 3 |
| Unsized cores, erosion | 5 | 5 |

It can be seen from Tables II-VI that the new development meets the desired requirements:
High strengths (Table II)
Lowering of the hot deformation (Table III)
Reduction in smoke evolution compared to cold box cores (Table IV)
Reduction of odor during storage of the cores (Table V)
Improvement in the tendency to form flash during casting compared to cold box (Table VI)

1.7. Production of Cores Using Hollow Ceramic Microspheres and an Exothermic Composition

The insulating feeders were produced using hollow ceramic microspheres having an Al₂O₃ content of about 30%, namely U-Spheres from Omega Minerals Germany GmbH (Norderstedt), as mold material.

As exothermic composition, the following composition was used:

| | |
|---|---|
| Aluminum (0.063-0.5 mm particle size) | 25% |
| Potassium nitrate | 22% |
| Hollow microspheres (U-Spheres from | 44% |
| Omega Minerals Germany GmbH) | |
| Refractory addition (chamotte) | 9% |

As an alternative, other conventional exothermic compositions can also be used. On this subject, reference may be made, for example, to the publications indicated in the above description and also the compositions reported in the examples of WO 00/73236.

1.7.1. Shaped Bodies with Hollow Microspheres—Insulating Feeders

The tubular shaped bodies having the dimensions Ø 60 mm (wall thickness: 10 mm)×150 mm were produced using the following mixture:

100 pbw of hollow microspheres

4 pbw of solid phenolic resin—Alnovol PN 332

4 pbw of technical-grade MDI (see above)

The preparation of the mixture, shaping and curing were carried out in a manner analogous to 1.1.3

1.7.2. Comparison of Smoke Intensity and Smoking Time

The abovementioned shaped bodies (1.7.1) were embedded in furan resin molds and filled with liquid aluminum (750° C.). After casting, smoke evolution was observed and evaluated using grades ranging from 1 (barely perceptible) to 10 (very strong). At the same time, the smoking time was measured.

TABLE VII

| | Smoke | Smoking |
|---|---|---|
| | intensity | time |
| Commercial insulating fiber feeder Kalminex ™ | 7 | 12 min. |
| (from Foseco) with an organic binder (thermally | | |
| cured phenolic resol) | | |
| Feeder (1.7.1) with novolak/polyisocyanate binder | 4 | 3 min. |

1.7.3. Shaped Bodies with Exothermically Acting Mixture—Exothermic Feeders

The tubular shaped bodies having the dimensions Ø 60 mm (wall thickness: 10 mm)×150 mm were produced using the following mixture.

100 pbw of exothermically acting mixture 4 pbw of solid phenolic resin—Alnovol PN 332

4 pbw of technical-grade MDI

The preparation of the mixture and shaping were carried out in a manner analogous to 1.1.3

1.7.4. Comparison of Ignition Time, Smoke Intensity and Smoking Time

The abovementioned shaped bodies (1.7.3) were laid on a plate which was at a temperature of 1000° C., the point in time at which ignition occurred was measured and smoke evolution (intensity and time) was observed. The smoke intensity was evaluated using grades ranging from 1 (barely perceptible) to 10 (very strong).

TABLE VIII

| | Ignition | Smoke | Smoking |
|---|---|---|---|
| | time | intensity | time |
| Commercial insulating | 1 min. | 7 | 5 min. |
| fiber feeder Kalminex ™ | | | |
| (from Foseco) with an | | | |
| organic binder (thermally | | | |
| cured phenolic resol) | | | |
| Feeder (1.7.3) with | 1 min. | 5 | 3 min. |
| novolak/polyisocyanate | | | |
| binder | | | |

It can be seen from Tables VII and VIII that the new development offers advantages over feeders on the market both in terms of smoke intensity and smoking time.

1. A process for producing shaped bodies, in particular cores, molds and feeders in foundry technology, which comprises the following steps:
preparing a composition comprising blending a phenolic resin in solid form, a polyisocyanate, and a refractory material,
at a temperature below the melting point of the phenolic resin;
molding the composition to form a shaped body; and
raising the temperature of the shaped body to above the melting point of the phenolic resin to cure the composition.

2. The process as claimed in claim 1, wherein the refractory material is mixed with the phenolic resin, to produce a mixture prior to addition of the polyisocyanate.

3. The process claim 1, wherein the molding to form a shaped body is carried out in a heated tool.

4. The process of claim 1, wherein the refractory material is selected from the group consisting of silica sand, olivine, chromite sand, zircon sand, vermiculite, synthetic mold materials such as Cerabeads and microspheres and mixtures thereof.

5. The process of claim 4, wherein the microspheres comprise hollow microspheres.

6. The process of claim 1, further comprising adding an exothermic constituent to the composition.

7. The process of claim 1, wherein the production of the shaped body is carried out without addition of a solvent.

8. The process of claim 1, wherein the polyisocyanate is dissolved in a solvent in which the phenolic resin is insoluble or sparingly soluble.

9. The process of claim 1, wherein the polyisocyanate comprises an isocyanate having at least 2, isocyanate groups per molecule.

10. The process of claim 1, wherein the polyisocyanate is selected from an aliphatic, cycloaliphatic, and an aromatic polyisocyanate and mixtures thereof.

11. The process of claim 10, wherein the aromatic polyisocyanate comprises diphenylmethane diisocyanate in admixture with its higher homologues.

12. The process of claim 1, wherein the phenolic resin comprises novolak.

13. The process of claim 1 further comprising curing the shaped body at a temperature of from about 150° C. to about 300° C.

14. The process of claim 13, wherein curing is carried out without addition of a catalyst.

15. The process of claim 1, further comprising adding a catalyst to the composition.

16. The process of claim 1 further comprising adding a compound which lowers the melting point of the phenolic resin to the composition.

17. A shaped body, in particular a core, mold or feeder for foundry technology, prepared by the process of claim 1.

18. The shaped body of claim 17 which is free of solvents or gaseous catalysts.

19. A composition for producing shaped bodies, in particular cores, molds and feeders, comprising
a solid phenolic resin,
a polyisocyanate, and
a refractory material.

20. The composition of claim 19, characterized in that the refractory material comprises hollow microspheres.

21. The composition of claim 19, wherein no solvent for either the phenolic resin or the polyisocyanate is present.

22. The composition of claims 19, wherein the phenolic resin comprises novolak.

23. The process of claim 1, wherein the refractory material is coated with the phenolic resin prior to the addition of the polyisocyanate.

24. The process of claim 4, wherein the hollow microspheres comprise aluminum silicate.

25. The process of claim 4, wherein the hollow microspheres have an aluminum oxide content greater than about 40% by weight.

26. The process of claim 4, wherein the hollow microspheres have an aluminum oxide content less than about 40% by weight.

27. The process of claim 6, wherein the exothermic constituent is selective from an oxidizable metal, an oxidant, fluorine carriers and mixtures thereof.

28. The process of claim 8 wherein the polyisocyanate solvent is selected from an aromatic solvent, a fatty acid solvent and mixtures thereof.

29. The process of claim 10, wherein the aromatic polyisocyanate is liquid at room temperature.

30. The process of claim 11, wherein the higher homologues comprise polymeric MDI having a functionality of from about 2 to about 4.

31. The process of claim 12, wherein the novolak has a melting point in the range from about 60 to about 120° C.

32. The process of claim 20, wherein the hollow microspheres comprise aluminum silicate.

33. The process of claim 20, wherein the hollow microspheres have an aluminum silicate content greater than about 40% by weight.

34. The process of claim 20, wherein the hollow microspheres have an aluminum silicate content less than about 40% by weight.

35. The process of claim 19, wherein the novolak has a melting point in the range from about 60 to about 120° C.
